(19) United States
(12) Patent Application Publication
(10) Pub. No.: US 2023/0289533 A1
(43) Pub. Date: Sep. 14, 2023

(54) Neural Topic Modeling with Continuous Learning

(71) Applicant: Siemens Aktiengesellschaft, München (DE)

(72) Inventors: Pankaj Gupta, München (DE); Yatin Chaudhary, München (DE); Thomas Runkler, München (DE)

(73) Assignee: Siemens Aktiengesellschaft, München (DE)

(21) Appl. No.: 18/040,700

(22) PCT Filed: Aug. 5, 2020
(86) PCT No.: PCT/EP2020/072041

§ 371 Date: Feb. 6, 2023

(51) Int. Cl. G06F 40/30

(52) U.S. Cl. CPC G06F 40/30

(57) ABSTRACT

Various embodiments of the teachings herein include a computer-implemented method for a topic modeling with a continuous learning. The method may include: extracting a current topic representation which represents a topic distribution over vocabulary within a current document; adjusting a size of the vocabulary of the current topic representation based on words used in a topic pool, wherein the topic pool includes past topic representations accumulated by each of past documents; regularizing the current topic representation by controlling a degree of topic imitation with past topic representations, based on comparison of the current topic representation and each of the past topic representations; and accumulating the regularized current topic representation into the topic pool.

### CROSS-REFERENCE TO RELATED APPLICATIONS

This application is a U.S. National Stage Application of International Application No. PCT/EP2020/072041 filed Aug. 5, 2020, which designates the United States of America, the contents of which are hereby incorporated by reference in their entirety.

### TECHNICAL FIELD

The present disclosure relates to neural topic modeling. Various embodiments include methods and/or systems for neural topic modeling with continuous learning.

### BACKGROUND

Unsupervised topic models, such as LDA (Blei et al., 2003), RSM (Salakhutdinov & Hinton, 2009), DocNADE (Lauly et al., 2017), NVDM (Srivastava & Sutton, 2017), etc. have been popularly used to discover topics from large document collections. However, in sparse data settings, the application of topic modeling is challenging due to limited context in a small document collection or short documents (e.g., tweets, headlines, etc.), and therefore the topic models produce incoherent topics. To deal with this problem, there have been several attempts (Petterson et al., 2010; Das et al., 2015; Nguyen et al., 2015; Gupta et al., 2019) that introduce prior knowledge to guide meaningful learning.

Lifelong Machine Learning (LML) (Thrun & Mitchell, 1995; Mitchell et al., 2015; Hassabis et al., 2017; Parisiet al., 2019) has recently attracted attention in building adaptive computational systems that can continually acquire, retain and transfer knowledge over life time in case of modeling continuous streams of information. In contrast, the prior machine learning is based on isolated learning i.e., a one-shot task learning (OTL) using a single dataset and thus, lacks ability to continually learn from incrementally available heterogeneous data. The application of LML framework has shown potential for supervised natural language processing (NLP) tasks (Chen & Liu, 2016) such as in sentiment analysis (Chen et al., 2015), relation extraction (Wang et al., 2019), text classification (de Masson d′Autume et al., 2019), etc. Existing works in topic modeling are either based on the OTL approach or transfer learning (Chen & Liu, 2014) using stationary batches of training data and prior knowledge without accounting for streams of document collections.

### SUMMARY

Teachings of the present disclosure include computer-implemented methods for a topic modeling with continuous learning. Some embodiments include: extracting a current topic representation which represents a topic distribution over vocabulary within a current document; adjusting a size of the vocabulary of the current topic representation based on words used in a topic pool, wherein the topic pool includes past topic representations accumulated by each of past documents; regularizing the current topic representation by controlling a degree of topic imitation with the past topic representations, based on comparison of the current topic representation and each of the past topic representations; and accumulating the regularized current topic representation into the topic pool.

As another example, some embodiments include a computer-implemented method for a topic modeling with a continuous learning, the method comprising: extracting (S22) a current topic representation which represents a topic distribution over vocabulary within a current document; adjusting (S24) a size of the vocabulary of the current topic representation based on words used in a topic pool, wherein the topic pool includes past topic representations accumulated by each of past documents; regularizing (S26) the current topic representation by controlling a degree of topic imitation with past topic representations, based on comparison of the current topic representation and each of the past topic representations; and accumulating (S28) the regularized current topic representation into the topic pool.

In some embodiments, the current topic representation is extracted based on a hidden vector and at least one parameter, wherein the hidden vector is configured to encode a topic proportion within the current document to represent a conditional probability of a word included in the current document based on a proceeding word of the word, and the at least one parameter is shared in calculating the hidden vector for another word included in the current document.

In some embodiments, the adjusting (S12) the size of the vocabulary includes masking at least one word of the vocabulary of the current topic representation, wherein the at least one masked word is not found in the topic pool.

In some embodiments, regularizing (S14) the current topic representation includes calculating a loss function which is related to probabilities of words in the adjusted size of vocabulary, wherein the loss function is defined in terms of the current topic representation and at least one parameter.

In some embodiments, regularizing (S14) the current topic representation includes adapting the current topic representation and the at least one parameter which minimize a value of the loss function.

In some embodiments, the adapted at least one parameter is used for extracting a future topic representation of a future document.

In some embodiments, the method, further comprises generating an augmented set including at least one of the past documents which has a perplexity value below a predetermined value, wherein the perplexity value is calculated based on the at least one adapted parameter.

In some embodiments, the method further comprises: performing topic learning for the augmented set of the past documents to detect overlapped domain between the past documents and the current document; and updating the at least one adapted parameter based on a result of the topic learning.

As another example, some embodiments include an apparatus configured to perform one or more of the methods described herein.

As another example, some embodiments include a computer-implemented method for a topic modeling with a continuous learning, the method comprising: retrieving (S32) at least two different word embeddings for a word from a word pool, which is accumulated by word embeddings for all words included in a plurality of past documents; generating (S34) a hidden vector which is configured to encode topic proportion within a current document, wherein the hidden vector is generated based on the at least two different embeddings for the word; computing (S36) a conditional probability of the word based on the hidden vector; and performing (S38) a topic modeling for the current document based on the computed conditional probability of the word.

In some embodiments, the different word embeddings for a word are encoded with different semantics.

In some embodiments, the hidden vector is generated for each word in the current document, and the hidden vector is generated in terms of proceeding words for each word.

In some embodiments, the method further comprises regularizing a result of the topic modeling by controlling a degree of topic imitation with past topic representations accumulated in a topic pool, based on comparison of the result of the topic modeling and each of past topic representations of the topic pool.

In some embodiments, the method further comprises: generating an augmented set including at least one of the past documents which has a perplexity value below a predetermined value, wherein the perplexity value is calculated based on the adapted at least one parameter; and performing topic learning for the augmented set of the past documents to detect overlapped domain between the past documents and the current document.

As another example, some embodiments include an apparatus configured to perform one or more of the methods described herein.

### BRIEF DESCRIPTION OF THE DRAWINGS

The teachings are explained in yet greater detail with reference to exemplary embodiments depicted in the drawings as appended. The accompanying drawings are included to provide a further understanding of the present and are incorporated in and constitute a part of the specification. The drawings illustrate the embodiments of the teachings herein and together with the description serve to illustrate the principles of the disclosure. Other embodiments and many of the intended advantages of the teachings herein will be readily appreciated as they become better understood by reference to the following detailed description. Like reference numerals designate corresponding similar parts.

The numbering of method steps is intended to facilitate understanding and should not be construed, unless explicitly stated otherwise, or implicitly clear, to mean that the designated steps have to be performed according to the numbering of their reference signs. In particular, several or even all of the method steps may be performed simultaneously, in an overlapping way or sequentially.

FIG. 1 shows an illustration of DocNADE architecture;

FIG. 2 shows a schematic flow diagram illustrating a computer-implemented method incorporating teachings of the present disclosure;

FIG. 3 shows a schematic flow diagram illustrating a computer-implemented method incorporating teachings of the present disclosure;

FIG. 4 shows a schematic flow diagram illustrating a computer-implemented method incorporating teachings of the present disclosure;

FIG. 5 shows a schematic flow diagram illustrating an application of computer-implemented method incorporating teachings of the present disclosure;

FIG. 6 shows a block diagram schematically illustrating an apparatus incorporating teachings of the present disclosure;

FIG. 7 shows a block diagram schematically illustrating a computer program product incorporating teachings of the present disclosure; and

FIG. 8 shows a block diagram schematically illustrating a data storage medium incorporating teachings of the present disclosure.

### DETAILED DESCRIPTION

The current topic representation may be extracted based on a hidden vector and at least one parameter, the hidden vector may be configured to encode a topic proportion within the current document to represent a conditional probability of a word included in the current document based on a proceeding word of the word, and the at least one parameter may be shared in calculating the hidden vector for another word included in the current document. Adjusting the size of the vocabulary may include masking at least one word of the vocabulary of the current topic representation, wherein the at least one masked word is not found in the topic pool.

Regularizing the current topic representation may include calculating a loss function which is related to probabilities of words in the adjusted size of vocabulary, wherein the loss function is defined in terms of the current topic representation and at least one parameter. Regularizing the current topic representation may include adapting the current topic representation and the at least one parameter which minimize a value of the loss function. The adapted at least one parameter may be used for extracting a future topic representation of a future document.

The example methods may further comprise generating an augmented set including at least one of the past documents which has a perplexity value below a predetermined value, wherein the perplexity value is calculated based on the at least one adapted parameter. In some embodiments, the method may further comprise: performing topic learning for the augmented set of the past documents to detect overlapped domain between the past documents and the current document; and updating the at least one adapted parameter based on a result of the topic learning.

In some embodiments, a computer-implemented method for a topic modeling with a continuous learning comprises: retrieving at least two different word embeddings for a word from a word pool, which is accumulated by word embeddings for all words included in a plurality of past documents; generating a hidden vector which is configured to encode topic proportion within a current document, wherein the hidden vector is generated based on the at least two different embeddings for the word; computing a conditional probability of the word based on the hidden vector; and performing a topic modeling for the current document based on the computed conditional probability of the word. The different word embeddings for a word may be encoded with different semantics. The hidden vector may be generated for each word in the current document, and the hidden vector is generated in terms of proceeding words for each word.

In some embodiments, the method may further comprise regularizing a result of the topic modeling by controlling a degree of topic imitation with past topic representations accumulated in a topic pool, based on comparison of the result of the topic modeling and each of past topic representations of the topic pool.

In some embodiments, the method may further comprise: generating an augmented set including at least one of the past documents which has a perplexity value below a predetermined value, wherein the perplexity value is calculated based on the adapted at least one parameter; and performing topic learning for the augmented set of the past documents to detect overlapped domain between the past documents and the current document.

In some embodiments, a computer-implemented method for a topic modeling with a continuous learning comprises: extracting a current topic representation which represents a topic distribution over vocabulary within a current document, wherein the current topic representation is extracted based on a hidden vector and at least one parameter, which is shared in calculating the hidden vector for another word included in the current document; generating an augmented set including at least one of past documents which has a perplexity value below a predetermined value, wherein the perplexity value is calculated based on the at least one parameter; performing topic learning for the augmented set of the past documents to detect overlapped domain between the past documents and the current document; and updating the at least one parameter based on a result of the topic learning.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. Generally, this application is intended to cover any adaptations or variations of the specific embodiments discussed herein.

In some embodiments, a neural topic modeling for an unsupervised document within a continual lifelong learning paradigm to enable knowledge-augmented topic learning over lifetime. In this disclosure, the neural topic modeling according to the present disclosure may be referred to as Lifelong Neural Topic Modeling (LNTM) capable of mining and retaining prior knowledge (topics) from streams of large document collections, and particularly guiding topic modeling on sparse datasets using accumulated knowledge of several domains over lifespan.

In the present disclosure, it may be provided with building LNTM framework, which includes: topic extraction, knowledge mining, retention, transfer and accumulation. For example, a stream of document collections S = {Ω¹, Ω², . . ., Ω^{T}, Ω^{T+1}} over lifetime t ∈ [1, ..., T, T + 1] may be provided in the present disclosure, where Ω^{T+1} is used to perform future learning.

The term ‘past document’ or ‘prior document’ may refer to a set of documents input in the past at task t ∈ [1, ..., T]. The term ‘past topic’ or ‘prior topic’ may refer to a set of topics extracted from past document or prior document, and may be accumulated in a topic pool (TopicPool).

The term ‘current document’ or ‘present document’ may refer to a set of documents input in the present at task t ∈ [T+1]. The term ‘current topic’ or ‘present topic’ may refer to a set of topics extracted from the current document or present document, and may be not yet accumulated in topic pool (TopicPool).

The term ‘future document’ may refer to a set of documents that will be input in the future. The term ‘future topic’ may refer to a set of topics extracted from the future document.

According to an example of the present disclosure, a DocNADE (“Larochelle & Lauly, 2012”; “Lauly et al., 2017”) may be adopted as a backbone for building the LNTM. However, DocNADE is one of examples for topic modeling, therefore other topic modelings may be alternatively adopted.

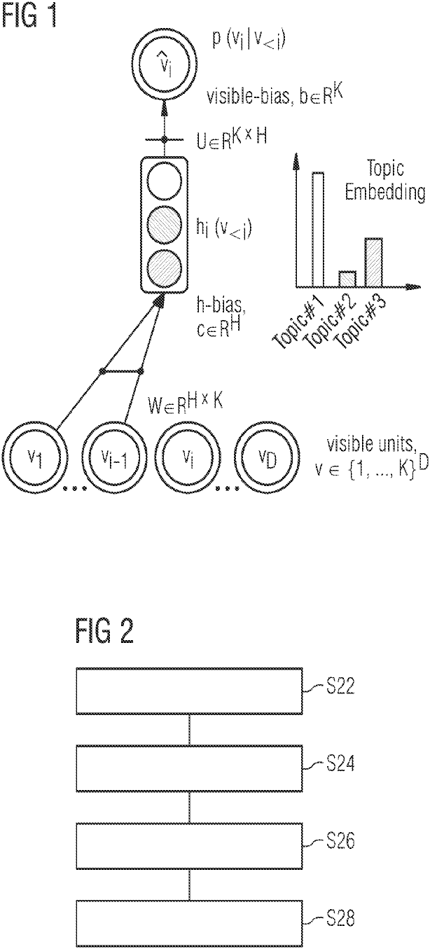

Hereinafter, DocNADE (Document Neural Autoregressive Distribution Estimation) is described. FIG. 1 shows an illustration of DocNADE architecture. For a document (observation vector) v ∈ Ω of size D such that v = (v₁, ...v_{D}), each word index vᵢ takes a value in vocabulary {1, ..., K} of size K. As shown in FIG. 1, DocNADE is configured to compute the probability

$${\hat{v}}_{\text{i}} = \text{p} \left({\text{v}}_{\text{i}} \left|\text{v} \text{<} \text{i ;} \text{Θ}\right)\right)$$

of the i^{th} word vᵢ conditioned on position dependent hidden layer hᵢ(v<i). More specifically, DocNADE computes the joint probability distribution

$$\text{p} \left(\text{v} \text{;} \text{Θ}\right) =$$

$${\prod }_{i = 1}^{D} p \left({v}_{i} \left|{V}_{< i} ; \text{Θ}\right)\right)$$

of words in the document v by factorizing it as a product of conditional distributions

$$\text{p} \left({\text{v}}_{\text{i}} \left|\text{v<i ;}\right) \text{Θ}\right) ,$$

where each conditional is efficiently modeled via a feed-forward neural network using proceeding word v<i in the sequence.

A hidden layer hᵢ (v<i) may be configured to encode topic proportion for the document v. As described in Equation 1, the DocNADE computes a hidden vector hᵢ (v<i) at each autoregressive step.

$${h}_{i} \left(V < i\right) = g \left(c + {\sum }_{q < i} {W}_{: , {q}_{v}}\right) a n d g = \left\{s i g m o i d , t a n h\right\} \qquad \text{[Equation 1]}$$

$$p \left({v}_{i} = w \left|{V}_{< i} ; \text{Θ}\right)\right) = \frac{exp \left({b}_{w} + {U}_{w , :} {h}_{i} \left({V}_{< i}\right)\right)}{{\sum }_{w} , exp \left({b}_{w} , + {U}_{w} {,}_{, :} {h}_{i} \left({V}_{< i}\right)\right)} \qquad \text{[Equation 2]}$$

In equation 2, for each i ∈ {1, ...D}, where v<i ∈ {v₁, ..., vᵢ₋₁} is a sub-vector consisting of all v_{q} such that q < i. Θ is a collection of parameters including weight matrices {W ∈ R^{H×K}, U ∈ R^{KxH}} and biases {c ∈ R^{H}, b ∈ R^{K}}. H and K are the number of hidden units (topics) and vocabulary size.

The parameter W may be shared in the feed-forward networks, therefore hᵢ (v<i) may be calculated based on same parameter W for different v. The topic model according to DocNADE computes objective function, e.g. negative log-likelihood L(v; Θ) that is minimized using stochastic gradient descent. Algorithm 1 lines #1 to #4 and Algorithm 2 describe computation of objective function that is minimized using stochastic gradient descent.

[Algorithm 1]: Lifelong neural topic modeling using DocNADE

input Sequence of document collections {Ω¹,... , Ω^{T}, ... , Ω^{T+1}}
input Past Learning: { Θ¹, ... , Θ^{T}, ... , Θ^{T+1}}
input TopicPool: {Z¹, ..., Z^{T}}
input WordPool: {E¹, .., E^{T}}
parameters Θ^{T+1}= {b, c, W, U, A¹, ..., A^{T}, p¹, ..., P^{T}}
hyper-parameters ${\text{Φ}}^{\text{T+1}} = \left\{\text{H,} {\text{λ}}_{L N T M}^{1} , … , {\text{λ}}_{L N T M}^{T}\right\}$ 1: Neural Topic Modeling:
2: LNTM = {}
3: Train a topic model and get PPL on test set ${\text{Ω}}_{t e s t}^{T + 1} :$ 4: PPL^{T+1},Θ^{T+1} ← topic-learning (Ω^{T+1},Θ^{T+1})
5: Lifelong Neural Topic Modeling (LNTM) framework:
6: LNTM = {EmbTF, TR, SAL}
7: For a document v ∈ Ω^{T+1}:
8: Compute loss (negative log-likelihood):
9: L(v;Θ^{T+1}) ← compute-NLL (v, 8^{T+1}, LNTM)
10: if TR in LNTM then
11: Jointly minimize-forgetting and learn with TopicPool:
12: ${Δ}_{T R} ← {\sum }_{t = 1}^{T} {\text{λ}}_{T R}^{t} \left(\left‖{Z}^{t} - {A}^{t} {Z}^{T + 1} \left‖{}_{2}^{2} + {\left‖{U}^{T} - {P}^{t} U\right‖}_{2}^{2}\right)\right)\right)$ 13: L(v; Θ^{T+1}) ← L(v; Θ^{T+1}) + Δ_{TR}
14: end if
15: if SAL in LNTM then
16: Detect domain-overlap and select relevant historical
documents from [Ω¹,... , Ω^{T}] for augmentation at task (T+1);
17: ${\text{Ω}}_{a u g}^{T + 1}$ ← distill-documents (Θ^{T+1},PPL^{T+1}, [Ω¹, ...,Ω^{T}])
18: Perform augmented learning (co-training) with ${\text{Ω}}_{a u g}^{T + 1} :$
19: ${Δ}_{S A L} ← {\sum }_{\left({\text{v}}^{t} , t\right) ∈ {\text{Ω}}_{a u g}^{T + 1}} {\text{λ}}_{S A L}^{T} L \left({\text{v}}^{\text{t}} ; {\text{Θ}}^{T + 1}\right)$
20: $L \left(\text{v;} {\text{Θ}}^{T + 1}\right) ← L \left(\text{v;} {\text{Θ}}^{T + 1}\right) {Δ}_{S A L}$ 21: end if
22: Minimize L(v;Θ^{T+1}) using stochastic gradient-descent
23: Knowledge Accumulation:
24: TopicPool ← accumulate-topics (Θ^{T+1})
25: WordPool ← accumulate-word-embeddings (Θ^{T+1})

In terms of model complexity, computing hᵢ (v<i) is efficient (linear complexity) due to NADE (Larochelle & Murray, 2011) architecture that leverages the pre-activation aᵢ₋₁ of (i-1)^{th} step in computing aᵢ. The complexity of computing all hidden layers hᵢ (v<i) is in O (DH) and all p (vᵢ | v<i; Θ) in O (KDH) for D words in the document v. Thus, the total complexity of computing the joint distribution p(v) is in O(DH + KDH).

TOPIC-LEARNING utility according to the present disclosure is described in Algorithm 2.

[Algorithm 2]: Lifelong learning utilities

1: function topic-learning (Ω,Θ)
2: Build a DocNADE neural topic model: Initialize Θ
3: for v ∈ Ω_{Train} do
4: Forward-pass:
5: Compute loss, L(v;Θ) ← compute-NLL (v;Θ)
6: Backward-pass:
7: Minimize L(v;Θ) using stochastic gradient-descent
8: end for
9: Compute perplexity PPL of test set Ωₜₑₛₜ :
10: $\text{PPL} ← \text{exp} \left(\frac{1}{\left|{\text{Ω}}_{t e s t}\right|} {\sum }_{\text{v} ∈ {\text{Ω}}_{t e s t}} \frac{L \left(\text{v;} \text{Θ}\right)}{\left|\text{v}\right|}\right)$ 11: return PPL, Θ
12: end function
13: function compute-NLL (v,Θ,LNTM={})
14: Initialize a ← c and p(v) ← 1
15: for word i ∈ [1, ..., N] do
16: hᵢ (v<i) ← g(a), where g={sigmoid, tanh}
17: $p \left({v}_{i} = w \left|{V}_{< i}\right)\right) ← \frac{exp \left({b}_{w} + {U}_{w , :} {h}_{i} \left({V}_{< i}\right)\right)}{{\sum }_{w} , exp \left({b}_{w} , + {U}_{w} {,}_{, :} {h}_{i} \left({V}_{< i}\right)\right)}$ 18: p(v) ← p(v)p(vᵢ|v < i)
19: Compute pre-activation at i^{th} step: a ← a+W_{:,vi}
20: if EmbTF in LNTM then
21: Get word-embedding vectors for vᵢ from WordPool:
22: $\text{a} ← \text{a +} {Σ}_{t = 1}^{T} {λ}_{E m b T F}^{t} {W}_{: , v i}^{t}$
23: end if
24: end for
25: return - log p (v;Θ)
26: end function
27: function distill-documents (Θ^{T+1},PPL^{T+1},[Ω¹, ... ,Ω^{T}])
28: Initialize a set of selected documents : ${\text{Ω}}_{a u g}^{T + 1}$ ← { }
29: for task t ∈ [1, ..., T] and document v^{t} ∈ Ω^{t} do
30: L(v^{t}; Θ^{T+1}) ← compute-NLL (v^{t},Θ^{T+1},LNTM = {})
31: $\text{PPL} \left({\text{v}}^{t} ; {\text{Θ}}^{T + 1}\right) ← \text{exp} \left(\frac{L \left({\text{v}}^{t} ; {\text{Θ}}^{T + 1}\right)}{\left|{\text{v}}^{t}\right|}\right)$ 32: Select document v^{t} for augmentation in task T+1:
33: if PPL (v^{t};Θ^{T+1}) ≤ PPL^{T+1} then
34: Document selected: ${\text{Ω}}_{a u g}^{T + 1} ← {\text{Ω}}_{a u g}^{T + 1} \text{U} \left({\text{v}}^{t} , t\right)$ 35: end if
36: end for37: return ${\text{Ω}}_{a u g}^{T + 1}$ 38: end function

Meanwhile, the topic-word matrix W ∈ R^{H×K} has a property that the row-vector Wⱼ,: encodes j^{th} topic (distribution over vocabulary words), i.e., topic-embedding. Whereas, the column-vector W_{:},ᵥᵢ corresponds to embedding of the word vᵢ, i.e., word-embedding.

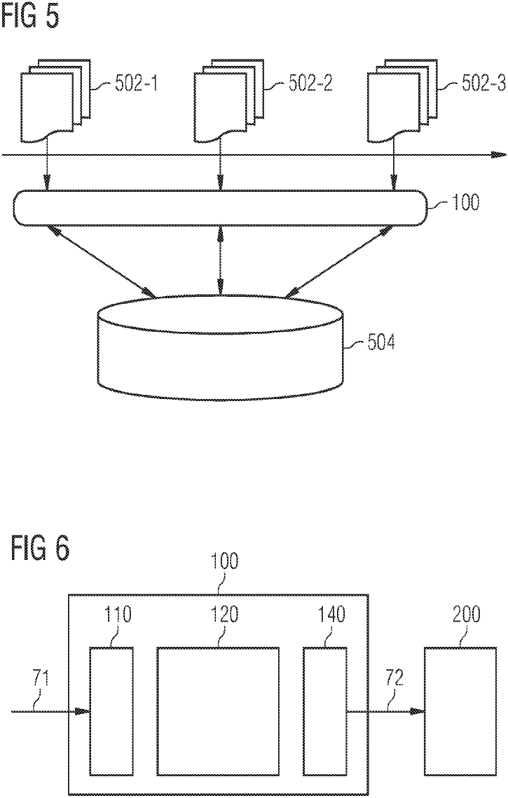

FIG. 2 shows a schematic flow diagram illustrating a computer-implemented method incorporating teachings of the present disclosure. The steps described in FIG. 2 may be performed by an apparatus 100 as illustrated in FIG. 6.

In step S22, the apparatus 100 may extract a current topic representation from a current document. The current topic representation may represent a set of topic extracted from a current document. The topic representation may represent a topic distribution over vocabulary within the current document. The topic representation may include at least one latent topic vector. Each latent topic vector may be related to a corresponding topic. The topic representation at task t may be referred to as a topic embedding matrix Z^{t}. Thus, the present topic representation at task T+1 may be denoted as Z^{T+1}. The current document may be a document or a collection of documents input at current task T+1.

The topic representation may be extracted by a topic modeling. In machine learning and natural language processing, a topic model is a type of statistical model for discovering the abstract “topics” that occur in a collection of documents. Topic modeling is a frequently used text-mining tool for discovery of hidden semantic structures (e.g. latent topics) in a text body. The “topics” produced by topic modeling techniques are clusters of similar words. A topic model captures this intuition in a mathematical framework, which allows examining a set of documents and discovering, based on the statistics of the words in each, what the topics might be and what each document’s balance of topics is. A topic is essentially a distribution over vocabulary that explains thematic structures in the document collection.

The topic modeling may be LDA (Blei et al., 2003), RSM (Salakhutdinov & Hinton, 2009), DocNADE (Lauly et al., 2017), NVDN (Srivastava & Sutton, 2017), etc.

In some embodiments, the topic modeling may be the DocNADE. Therefore, the topic representation may be extracted by p(vᵢ|v<i; Θ) which is defined based on a hidden vector. The parameter Θ may be determined by a loss function. The parameter may include at least one of a hidden bias vector (referred to as c in Equation 1), a visible bias vector (referred to as b in Equation 2), an encoding matrix (referred to as W in Equation 1), and a decoding matrix (referred to as U in Equation 2). Each parameter may be determined to maximize an accuracy of a result of the topic modeling.

The loss function is a function that maps an event or values of one or more variables. The loss function is used for parameter estimation, and the event in question is some function of the difference between estimated and true values for an instance of data. Thus, the parameters which minimize the loss function may be determined based on the parameter estimation.

The parameter Θ at task T determined in this step may be referred to as ‘a present parameter’ or ‘a current parameter’. According to DocNADE, the current topic representation may be extracted based on a hidden vector and at least one parameter. The hidden vector may be configured to encode a topic proportion within the current document to represent a conditional probability of a word included in the current document based on a proceeding word of the word. The at least one parameter may be shared in calculating the hidden vector for another word included in the current document.

In step S24, the apparatus 100 may adjust a size of the vocabulary of the current topic representation based on words accumulated in a topic pool. In modeling a stream of document collections, the vocabulary size may not be same in tasks over lifetime. Thus, it may be required to have common vocabulary words in the participating topics for a topic analogy (e.g., shifts, overlap, etc.).

The size of the vocabulary may be adjusted by masking at least one word of the vocabulary of the current topic representation. The word in the vocabulary may be masked when the word is not found in the topic pool. The word in the vocabulary may be masked when the word is not appeared in topic representation accumulated in the topic pool. In other words, the at least one masked word is not found in the topic pool. Thus, the current topic representation Z^{T+1} can be obtained from the row-vectors of W ∈ Θ^{T+1} by masking all its column-vectors vᵢ not appeared in the past task.

Therefore, each latent topic vector in topic representation Z of the current task T+1 may be configured to encode a distribution over words appearing in the past tasks, e.g., Z^{T} ∈ TopicPool. The topic pool (TopicPool) may include topic representation Z^{t} corresponding to each task t. Thus, the topic pool may be accumulated by topic representations at from task 1 to task T.

In step S26, the apparatus 100 may regularize the current topic representation. In some embodiments, the step of regularizing may include controlling a degree of topic imitation with past topic representations accumulated in the topic pool. The step of regularizing may include comparing the current topic representation with each of past topic representations of the topic pool.

In this step, a topic-regularization term Δ_{TR} may be introduced as described in equation 3.

$${Δ}_{T R} = {\sum }_{t = 1}^{T} {\text{λ}}_{T R}^{t} \left(\left‖{Z}^{t} - {A}^{t} {Z}^{T + 1} \left‖{}_{2}^{2} + {\left‖{U}^{T} - {P}^{t} U\right‖}_{2}^{2}\right)\right)\right) \qquad \text{[Equation 3]}$$

Where,

$${\text{λ}}_{T R}^{t}$$

is a per-task regularization strength that controls the degree of topic-imitation and forgetting of prior learning t by the current task T+1, Z^{t} is topic representation at task t, A^{t} ∈ R^{H×H} is topic-alignment in Z^{t} and Z^{T+1}, U^{t} is decoding matrix of DocNADE for task t, and P is a projection matrix to align decoder matrices and to remember the information of the past, similar to A (in encoder side). Referring to equation 3, (Z^{t}, U^{t}) ∈ Θ^{t} are parameters at the end of the past task t=T.

Referring to equation 3, the first term (referred to as a topic-imitation term) of the topic-regularization term allows controlled knowledge transfer by inheriting relevant topic representation(s) in Z^{T-1} from TopicPool. Thus, the apparatus 100 may control a degree of topic imitation with past topic representations accumulated in the topic pool. The topic imitation may be calculated per each of past topic representations of the topic pool. In other words, a degree of topic imitation of the current topic representation with each of past topic representations may be controlled by

$${\text{λ}}_{T R}^{t} .$$

As shown in the topic-imitation term, domain-shifts may be also accounted via a topic alignment matrix A^{t} ∈ R^{H×H} for every prior task. By using the topic alignment matrix, the apparatus 100 may precisely compare the current topic representation with each of past topic representations of the topic pool. The topic regularization term Δ_{TR} enables jointly mining, transferring and retaining prior topics when learning future topics continually over lifetime.

The second term may be referred to as ‘encoder and/or decoder proximity’ term. Decoder proximity may represent a degree of similarity in the decoding parameters U^{T+1} and U^{t} of the topic models over time. Likewise, Encoder proximity may represent a degree of similarity in the encoding parameters W^{T+1} and W^{t} of the topic models over time. Therefore, the proximity refers to capturing similar information by the weight parameters of the topic model.

The combination of the first term and the second term may together preserve the prior learning with encoder and decoder proximity, respectively due to a quadratic penalty on the selective difference between the parameters for the past and current topic modeling tasks, such that the parameters Θ^{T} also retain representation capabilities for the document collections in the past, e.g., L (Ω^{t}; Θ^{t}) ~ L (Ω^{t}; Θ^{T+1}) .

The topic-regularization term (Δ_{TR}) may be used for its objective function L (Ω^{T+1}; Θ^{T+1}) as described in equation 4.

$$L \left({\text{Ω}}^{T + 1} ; {\text{Θ}}^{T + 1}\right) = {\sum }_{V ∈ {\text{Ω}}^{T + 1}} L \left(\text{v;} {\text{Θ}}^{T + 1}\right) + {Δ}_{T R} \qquad \text{[Equation 4]}$$

The objective function as described in equation 4 may be a loss function (negative log-likelihood) for topic regularization. In the present disclosure, a loss function is used for parameter estimation.

Referring to Equation 4, the parameter Θ^{T+1} may be optimized to minimize the negative log-likelihood. The parameter Θtask T+1 determined in this step may be referred to as ‘a future parameter’. The future parameter may be used for extracting a future topic representation of a future document at task T+2 or tasks after T+2.

In summarizing, the apparatus 100 may calculate a loss function which is related to probabilities of words in the adjusted size of vocabulary, wherein the loss function is defined in terms of the current topic representation and at least one parameter. Also, the apparatus 100 may adapt the current topic representation and the at least one parameter which minimize a value of the loss function for topic regularization as described in equation 4.

In step S28, the apparatus 100 may accumulate the regularized current topic representation into the topic pool.

In this present disclosure, the steps described in FIG. 2 may be referred to as ‘Topic Regularization (TR)’. The TR process is also demonstrated in Algorithm 1 lines #10-14. TR process enables topical knowledge transfer from several domains and prevents catastrophic forgetting in the past topics. In addition to TR process, following steps may be further proceeded. The following steps may be referred to as ‘Selective-Data Augmentation Learning (SAL)’. The SAL process may be performed to share representations among tasks and to minimize catastrophic forgetting by data replay (augmentation). The SAL process may include at least two steps, e.g. document distillation and selective co-training, as described below.

The apparatus 100 may generate an augmented set including at least one of the past documents which has perplexity value above a predetermined value. This step may be referred to as a document distillation. The augmented set of past documents may include past document whose perplexity value is below the predetermined value. The perplexity value may be calculated based on the adapted at least one parameter described in step S26. The perplexity value is a measurement of how well a probability distribution or probability model predicts a sample. The perplexity value may be used to compare probability models. A low perplexity value indicates the probability distribution is good at predicting the sample.

More specifically, given document collections [Ω¹,...,Ω^{T}] of the past tasks, documents found not relevant in modeling a future task due to domain shifts may be ignored. For that, the apparatus 100 may build a topic model with parameters Θ^{T} over Ω^{T} and compute an average perplexity (PPL^{T}) score on its test set

$${\text{Ω}}_{t e s t}^{T + 1} .$$

Then, an augmented set

$${\text{Ω}}_{a u g}^{T + 1}$$

⊂ [Ω¹, ..., Ω^{T}] such that each document v^{t} ∈

$${\text{Ω}}_{a u g}^{T + 1}$$

of a past task t satisfies: PPL(v^{t}; Θ^{T+1}) ≤ PPL^{t+1}. In essence, this unsupervised document distillation scheme detects domain-overlap in the past and future tasks based on representation ability of Θ^{T+1} for documents of the past.

The procedure of document distillation is described in Algorithm 1 lines #17, and Algorithm 2 lines #27-38.

After the document distillation, the apparatus 100 may perform topic learning for the augmented set of the past documents to detect overlapped domain between the past documents and the current document. This step may be referred to as a selective co-training.

In other words, the topic modeling over Ω^{T+1} simultaneously using

$${\text{Ω}}_{a u g}^{T + 1}$$

may be re-trained, by leveraging topical homologies Δ_{SAL} in selective documents of the past and current tasks as described in equation 5.

$${Δ}_{S A L} = {\sum }_{\left({\text{v}}^{t} , t\right) ∈ {\text{Ω}}_{a u g}^{T + 1}} {\text{λ}}_{S A L}^{t} L \left({\text{v}}^{t} ; {\text{Θ}}^{T + 1}\right) \qquad \text{[Equation 5]}$$

Here,

$${\text{λ}}_{S A L}^{t}$$

is per-task contribution that modulates influence ofshared representations while co-training with selected documents of the past task t.

$$L \left({\text{Ω}}^{T + 1} ; {\text{Θ}}^{T + 1}\right) = {\sum }_{\text{v} ∈ {\text{Ω}}^{T + 1}} L \left(\text{v;} {\text{Θ}}^{T + 1}\right) + {Δ}_{S A L} \qquad \text{[Equation 6]}$$

The objective function as described in equation 6 may be a loss function (negative log-likelihood) which is to be minimized. In the present disclosure, a loss function is used for parameter estimation. By using equation 6, the at least one parameter adapted in step S26 may be updated.

The procedure of selective co-training is described in Algorithm 1 lines #18-20. SAL process jointly may lead to transferring prior knowledge from several domains, to minimizing catastrophic forgetting and to reducing training time due to selective data replay over lifetime. In other words, SAL process identifies relevant documents from historical collections, learns topics simultaneously with a future task and controls forgetting due to selective data replay.

When TR and SAL process are combined, the overall loss in modeling documents Ω^{T+1} of the current task T + 1 may be described as equation 7.

$$L \left({\text{Ω}}^{T + 1} ; {\text{Θ}}^{T + 1}\right) = {\sum }_{\text{v} ∈ {\text{Ω}}^{T + 1}} L \left(\text{v;} {\text{Ω}}^{T + 1}\right) + {Δ}_{T R} + {Δ}_{S A L} \qquad \text{[Equation 7]}$$

In some embodiments, the SAL process is performed in combination of TR process, however it should be noted that the SAL can be performed as taken alone.

FIG. 3 shows a schematic flow diagram illustrating a computer-implemented method incorporating teachings of the present disclosure. The steps described in FIG. 3 may be performed by an apparatus 100 as illustrated in FIG. 6.

In some embodiments, complementary to topics, pre-trained word embeddings accumulated in a word pool (WordPool) may be utilized during lifelong learning. The word pool may include word embedding (word embedding representation) appeared in the past documents. The steps demonstrated in FIG. 3 may be referred to as ‘Embedding transfer (EmbTF)’ process. EmbTF process is performed based on pre-trained word embeddings E from several sources (i.e., multi-source transfer learning) during learning topics Z^{T+1} for the current task T + 1. The EmbTF process is also illustrated in Algorithm 1 lines #7-9 and Algorithm 2 lines #20-23. The EmbTF process introduces prior multi-domain knowledge encoded in word-embeddings.

In step S32, the apparatus 100 may retrieve at least two different word embeddings for a word from a word pool. The word pool may be accumulated by word embeddings for all words included in a plurality of past documents. The different word embeddings for a word is encoded with different semantics. More specifically, the word embedding for every word vᵢ may be accumulated while topic modeling over a stream of document collections from several domains. Thus, we have in total T number of embeddings (encoding different semantics) for a word vᵢ in WordPool, if the word appears in all the past collections.

In step S34, the apparatus 100 may generate a hidden vector which is configured to encode topic proportion within a current document, wherein the hidden vector is generated based on the at least two different embeddings for the word. The hidden vector may be generated for each word in the current document, and the hidden vector may be generated in terms of proceeding words for each word.

The hidden vector may reflect word embeddings accumulated in the word pool. The word pool in form of pre-trained word embeddings [E¹, ..., E^{T}] may be used in each hidden layer of DocNADE when analyzing Ω^{T+1}. In other words, the word pool accumulated during the past tasks may be reflected in DocNADE as described in equation 8.

$$\text{h} \left(V < i\right) = g \left(c + {\sum }_{q < i} {W}_{: , {q}_{v}} + {\sum }_{q < 1} {\sum }_{t = 1}^{T} {\text{λ}}_{E m b T F}^{t} {E}_{: , {v}_{q}}^{t}\right) \qquad \text{[Equation 8]}$$

Referring to equation 8, the term

$${\sum }_{q < i} {\sum }_{t = 1}^{T} {\text{λ}}_{E m b T F}^{t} {E}_{: , {v}_{q}}^{t}$$

is added to equation 1. It may be observed that the topic learning for task T + 1 is guided by an embedding vector E_{:,} _{vq} for the word v_{q} from each of the T domains (sources), where

$${\text{λ}}_{E m b T F}^{t}$$

is per-task transfer strength that controls the amount of prior (relevant) knowledge transferred to T + 1 based on domain overlap with the past task t. Meanwhile, the word embeddings E^{t} ∈ WordPool may be obtained from the column-vectors of parameter W at the end of the task t.

In step S36, the apparatus 100 may compute a conditional probability of the word based on the hidden vector. The hidden vector hᵢ (v<i) generated in step S34 may be adapted to equation 2 to calculate v̂ᵢ = p (vi | v<i; Θ) in terms of the hidden vector.

In step S38, the apparatus 100 may perform a topic modeling for the current document based on the computed conditional probability of the word.

In addition to EmbTF process, at least one of TR process and SAL process may be performed in combination.

For example, the apparatus 100 may generate an augmented set including at least one of the past documents which has perplexity value below a predetermined value. The perplexity value may be calculated based on the adapted at least one parameter. The apparatus 100 may perform topic learning for the augmented set of the past documents to detect overlapped domain between the past documents and the current document

For example, the apparatus 100 may regularize a result of the topic modeling by controlling a degree of topic imitation with past topic representations accumulated in a topic pool, based on comparison of the result of the topic modeling and each of past topic representations of the topic pool.

In some embodiments, the SAL process is performed in combination of TR process, however it should be noted that the SAL can be also performed as taken alone.

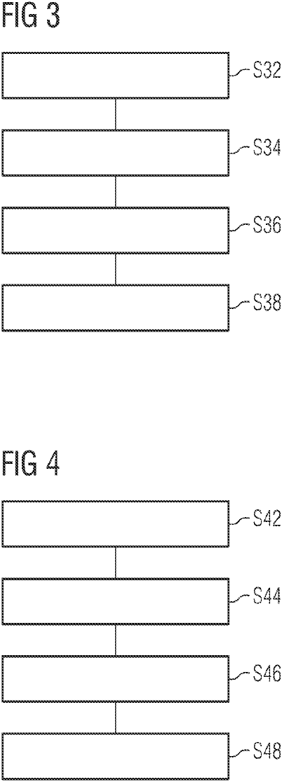

FIG. 4 shows a schematic flow diagram illustrating a computer-implemented method incorporating teachings of the present disclosure. The steps described in FIG. 4 may be performed by an apparatus 100 as illustrated in FIG. 5. The steps described in FIG. 4 illustrate SAL procedure. The SAL procedure may be performed to share representations among tasks and to minimize catastrophic forgetting by data replay (augmentation). Detailed procedures of SAL have been already described above.

Referring to FIG. 4, in step S42, the apparatus 100 may extract a current topic representation which represents a topic distribution over vocabulary within a current document. The current topic representation may be extracted based on a hidden vector and at least one parameter. The at least one parameter may be shared in calculating the hidden vector for another word included in the current document. The hidden vector may be configured to encode a topic proportion within the current document to represent a conditional probability of a word included in the current document based on a proceeding word of the word.

In step S44, the apparatus 100 may generate an augmented set including at least one of past documents which has a perplexity value below a predetermined value. The perplexity value may be calculated based on the at least one parameter.

In step S46, the apparatus 100 may perform topic learning for the augmented set of the past documents to detect overlapped domain between the past documents and the current document.

In step S48, the apparatus 100 may update the at least one parameter based on a result of the topic learning.

In some embodiments, the SAL procedure may be combined with at least one of TR and EmbTF procedures.

In some embodiments, the methods include: (1) detecting topic overlap in prior topics t ∈ [1, T] of the knowledge base (KB) and topics of new task T+1, (2) positively transferring prior topic information in modeling future task, (3) retaining or minimizing forgetting of prior topic knowledge, and (4) continually accumulating topics in KB over life time.

The technical benefits of the teachings of the present disclosure may include:
Maximizing transfer learning by accumulating knowledge over lifetime.
No need to persist/retain an AI-model for each time step. The apparatus 100 may keep on building, accumulating knowledge over lifetime and the apparatus 100 reuses them in future as knowledge base, that is, one single global model evolves/adapts over lifetime.
reducing complexity in modeling stream of data (documents): the apparatus 100 may reduce number of parameters and improve modularization in learning/acquiring knowledge over lifetime simulating human-like learning.
Fast decision making due to automatic document analysis and requirement assignment to experts.
Expedite tendering and bidding process via automatic topic assignment and requirement analysis, e.g., similar requirements retrieval, topic extraction, interpretability, etc.
Reducing non-conformance costs (NCCs) by similar-requirements-retrieval functionality in tenders, automatically maximizing coverage while analyzing critical requirements in long tender documents.

FIG. 5 shows a schematic flow diagram illustrating an application of computer-implemented method incorporating teachings of the present disclosure. In FIG. 5, an example of modeling a stream of industrial text-documents over time, for instance, a stream of tender documents from one or several tenants. At each time step, system according to the present disclosure learns tender representations, extracts topics and accumulates into a knowledge base of topics to better deal with tender documents in future.

As shown in FIG. 5, tender documents 502-1, 502-2, 502-3 are presented according to time flow. For example, tender document 502-1 represents documents received in the past, tender document 502-2 is documents receive in the current, and tender document 502-3 is documents that will be input in the future.

The tender document 502-1 may be input to the apparatus 100 according to the present disclosure. The apparatus 100 may accumulate topic representations and word embeddings extracted from the tender document 502-1 into knowledge base 504.

The tender document 502-2 may be input to the apparatus 100 according to the present disclosure. The apparatus 100 may regularize the tender document 502-2 based on the tender document 502-1, and accumulate topic representations and word embeddings extracted from the tender document 502-2 into the knowledge base 504.

When tender document 502-3 is input to the apparatus 100 according to the present disclosure, the apparatus 100 may regularize the tender document 502-3 based on the tender document 502-1, 502-2, and accumulate topic representations and word embeddings extracted from the tender document 502-3 into the knowledge base 504.

In some embodiments, it may exploit past topics and representations accumulated over time in order to perform transfer learning for a future task and thus, improve topic modeling and representation learning for the future task. In some embodiments, it may minimize forgetting the topics/representations of any past tender documents, thus all the past learning (i.e., of historical tenders) contributes in improving the quality of modeling a future tender document.

In some embodiments, it may perform information retrieval via tender-document similarities, extracts topics (list of keywords) as well as classifies or analyses requirements over lifetime in streams of tender documents from several tenants.

In some embodiments, it may offer the functionality to determine the importance of one or more historical tenants or sources (i.e., domain-overlap) while modeling a future tender-document with maximum transfer learning and minimum catastrophic forgetting.

In some embodiments, it may improve information retrieval and classification of requirements in tenders due to inherent transfer learning offers a reducing the number of models to maintain for each tenant in the stream of tender documents. Thus, a global model keeps on accumulating knowledge over lifetime and can model any historical and future data effectively exploiting lifelong learning and application like humans do.

FIG. 6 shows an apparatus 100 incorporating teachings of the present disclosure, i.e. an apparatus for topic modeling with continuous learning. In particular, the apparatus 100 is configured to perform one or more of the methods described herein, in particular the method as described in the foregoing with respect to FIG. 1 through FIG. 5.

In some embodiments, the apparatus 100 comprises an input interface 110 for receiving an input signal 71, wherein the task is to performing the bootstrapping. The input interface 100 may be realized in hard- and/or software and may utilize wireless or wire-bound communication. For example, the input interface 110 may comprise an Ethernet adapter, an antenna, a glass fiber cable, a radio transceiver and/or the like.

The apparatus 100 further comprises a computing device 120 configured to perform the steps S22 through S28, and/or S32 through S38 and/or S42 through S48. The computing device 120 may in particular comprise one or more central processing units, CPUs, one or more graphics processing units, GPUs, one or more field-programmable gate arrays FPGAs, one or more application-specific integrated circuits, ASICs, and or the like for executing program code. The computing device 120 may also comprise a non-transitory data storage unit for storing program code and/or inputs and/or outputs as well as a working memory, e.g. RAM, and interfaces between its different components and modules.

The apparatus may further comprise an output interface 140 configured to output an output signal 72, for example as has been described with respect to step S90 in the foregoing. The output signal 72 may have the form of an electronic signal, as a control signal for a display device 200 for displaying the semantic relationship visually, as a control signal for an audio device for indicating the determined semantic relationship as audio and/or the like. Such a display device 200, audio device or any other output device may also be integrated into the apparatus 100 itself.

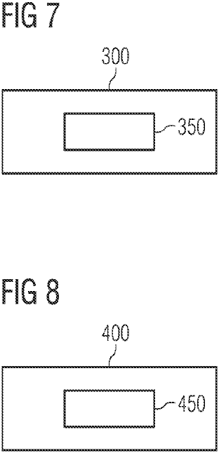

FIG. 7 shows a schematic block diagram illustrating a computer program product 300 incorporating teachings of the present disclosure, i.e. a computer program product 300 comprising executable program code 350 configured to, when executed (e.g. by the apparatus 100), perform one or more of the methods described herein, in particular the method as has been described with respect to FIG. 1 through FIG. 5 in the foregoing.

FIG. 8 shows a schematic block diagram illustrating non-transitory computer-readable data storage medium 400 incorporating teachings of the present disclosure, i.e. a data storage medium 400 comprising executable program code 450 configured to, when executed (e.g. by the apparatus 100), perform one or more of the methods described herein, in particular the method as has been described with respect to FIG. 1 through FIG. 5 in the foregoing.

In the foregoing detailed description, various features are grouped together in the examples with the purpose of streamlining the disclosure. It is to be understood that the above description is intended to be illustrative and not restrictive. It is intended to cover all alternatives, modifications and equivalence. Many other examples will be apparent to one skilled in the art upon reviewing the above specification, taking into account the various variations, modifications and options as described or suggested in the foregoing.

What is claimed is:

1. A computer-implemented method for a topic modeling with a continuous learning, the method comprising:
extracting a current topic representation which represents a topic distribution over vocabulary within a current document;
adjusting a size of the vocabulary of the current topic representation based on words used in a topic pool, wherein the topic pool includes past topic representations accumulated by each of past documents;
regularizing the current topic representation by controlling a degree of topic imitation with past topic representations, based on comparison of the current topic representation and each of the past topic representations; and
accumulating the regularized current topic representation into the topic pool.

2. The method of claim 1, further comprising:
Extracting the current topic representation based on a hidden vector and at least one parameter;
wherein the hidden vector is configured to encode a topic proportion within the current document to represent a conditional probability of a word included in the current document based on a proceeding word of the word; and
sharing the at least one parameter is shared in calculating the hidden vector for another word included in the current document.

3. The method of claim 1, wherein:
adjusting the size of the vocabulary includes masking at least one word of the vocabulary of the current topic representation; and
the at least one masked word is not found in the topic pool.

4. The method of claim 1, wherein:
regularizing the current topic representation includes calculating a loss function which is related to probabilities of words in the adjusted size of vocabulary; and
the loss function is defined in terms of the current topic representation and at least one parameter.

5. The method of claim 4, wherein regularizing the current topic representation includes adapting the current topic representation and the at least one parameter which minimize a value of the loss function.

6. The method of claim 5, further comprising using the adapted parameter for extracting a future topic representation of a future document.

7. The method of claim 5, further comprising
generating an augmented set including at least one of the past documents with a perplexity value below a predetermined value, wherein the perplexity value is calculated based on the at least one adapted parameter.

8. The method of claim 7, further comprising:
performing topic learning for the augmented set of the past documents to detect overlapped domain between the past documents and the current document; and
updating the at least one adapted parameter based on a result of the topic learning.

9. (canceled)

10. A computer-implemented method for a topic modeling with a continuous learning, the method comprising :
retrieving at least two different word embeddings for a word from a word pool accumulated by word embeddings for all words included in a plurality of past documents;
generating a hidden vector configured to encode topic proportion within a current document, wherein the hidden vector is generated based on the at least two different embeddings for the word;
computinga conditional probability of the word based on the hidden vector; and
performing a topic modeling for the current document based on the computed conditional probability of the word.

11. The method of claim 10, wherein the different word embeddings for a word are encoded with different semantics.

12. The method of claim 10, wherein:
the hidden vector is generated for each word in the current document; and
the hidden vector is generated in terms of proceeding words for each word.

13. The method of claim 10, further comprising
regularizing a result of the topic modeling by controlling a degree of topic imitation with past topic representations accumulated in a topic pool, based on comparison of the result of the topic modeling and each of past topic representations of the topic pool.

14. The method of claim 10, further comprising:
generating an augmented set including at least one of the past documents with a perplexity value below a predetermined value, wherein the perplexity value is calculated based on the adapted at least one parameter; and
performing topic learning for the augmented set of the past documents to detect overlapped domain between the past documents and the current document.

15. (canceled)
